(19) United States
(12) Patent Application Publication
(10) Pub. No.: US 2014/0022794 A1
(43) Pub. Date: Jan. 23, 2014

(54) LENS ARRANGEMENT AND ILLUMINATOR HOUSING

(71) Applicant: Petri Laukkanen, Salo (FI)

(72) Inventor: Petri Laukkanen, Salo (FI)

(73) Assignee: LEDIL OY, Salo (FI)

(21) Appl. No.: 13/553,858

(22) Filed: Jul. 20, 2012

(51) Int. Cl. F21V 14/06

(52) U.S. Cl. 362/268; 362/319

(57) ABSTRACT

A novel lens arrangement features a first lens which is configured to be fixed to a light source and features an aspherical convex exit surface for transmitting light which received from the light source. A second lens is arranged to the optical axis of the first lens and features an aspherical concave entry surface which is arranged to receive light which transmitted by the first lens and which has substantially the same shape as that of the exit convex surface of the first lens. The first and second lens are configured to be moved along the optical axis in respect to each other between a minimum extended position, wherein the exit surface of the first lens is nested into the matching concave entry surface of the second lens, and maximum extended position, wherein second lens lies at the focal point of the first lens.

### FIELD OF THE INVENTION

The present invention relates to lighting. In particular, the invention relates to a lens arrangement for an illuminator and to an illuminator housing for providing flush installed lighting.

### BACKGROUND ART

Lighting is an important part of interior design. With ever rising awareness of energy consumption and significance of the quality of artificial light, producers and consumers alike have turned to LED's as an alternative in indoor lighting. LED's are known for their low power consumption and pleasant range of wavelength corresponding to that of natural light.

There are a vast number of LED illuminators commercially available for indoor lighting. However, while there is ample supply of LED illuminators for consumers, there is scarce supply of LED illuminators for providing lighting for places of commerce, such as jewelry stores. Places of commerce typically set a particular set of boundaries for lighting solutions. In addition to economical and pleasant for the eye, the produced pattern of light shall preferably be adjustable such that each source of light can be turned into a spot light for illuminating a particular object, such as a watch in a jewelry store, and into a source of ambient light featuring a diffused light pattern. The illuminator should also be suitable for flush installation to avoid any protuberances from the carefully selected and branded furniture.

U.S. Pat. No. 8,047,684 B2 discloses an LED illuminator having a lens arrangement which features two adjustable lens sets. By retracting and extending the two lens sets, the light pattern may be altered. The light pattern is altered by moving either or both coaxial lenses in respect to a fixed LED. The axial movement of the lenses is established via nested threaded lens housings which can be rotated in respect to each other and in respect to the LED. However, U.S. Pat. No. 8,047,684 B2 provides no solution for establishing a source of an adjustable artificial which can be flush installed into furniture of a place of business, for example. If the illuminator is fixed to the receiving structure from the outmost lens housing, the light pattern cannot be adjusted. If the illuminator is fixed to the receiving structure from the inner lens housing or from the illuminator housing, the illuminator will protrude from the structure. Albeit providing an adjustable light beam, the illuminator disclosed in U.S. Pat. No. 8,047,684 B2 is for reasons given above unsuitable for flush installation and therefore unsuitable for most commercial applications.

WO 2006/072885 A1 discloses a variable beam lighting device for a flashlight featuring two mutually retractable optical elements. The first optical element is configured to receive a light source in an embedded manner and the superposed second optical element is configured to refract the light transmitted through the first lens. By rotation of the superposed second optical elements, the convergence and divergence of the light beam is varied about the optical axis of the device. The optical elements are separated by a compartment. The optical elements carry a plurality of ring-shaped lenses which are defined by respective annular concentric ridges radially facing each other and which extend circumferentially about the optical axis. Accordingly, it is possible to adjust the beam emitted by the lighting device by means of small axial shifts, whereby the device also has a small size. Furthermore, the image of the source is broken down by the lenses so as to be no longer visible in the beam emitted by the light source. However, by rotating adjustment motion, the size of the device of WO 2006/072885 A1 varies also making it unsuitable for most commercial applications as explained above.

### SUMMARY

The aim of the present invention is achieved with aid of a novel lens arrangement for an illuminator. The novel lens arrangement features two lenses and an adjustment mechanism for adjusting the mutual position of the lenses and therefore the light pattern produced by said lenses. The first lens is configured to be fixed to a light source and features an aspherical convex exit surface for transmitting light which received from the light source. The first lens transmits light on an optical axis, whereby the first lens also has a focal point on the optical axis. The second lens is arranged to said optical axis. The second lens features an aspherical concave entry surface which is arranged to receive light which transmitted by the first lens. The second lens also includes an exit surface for transmitting light from the arrangement. The concave entry surface of the second lens has substantially the same shape as that of the exit convex surface of the first lens. Further, the adjustment mechanism which connected to the second lens such that the mechanism is configured to move the second lens along the optical axis in respect to the first lens between a minimum and maximum extended position. In the minimum extended position, the convex exit surface of the first lens is nested into the matching concave entry surface of the second lens. In the maximum extended position, the second lens lies at the focal point of the first lens.

More specifically, the lens arrangement according to the present invention is characterized by claim 1.

On the other hand, the aim of the invention is also achieved with an illuminator housing having a lens arrangement as defined in claim 19.

Considerable benefits are gained with aid of the present invention. The cooperating shapes of the exit convex surface of the first lens and the concave entry surface of the second lens allow said surfaces to match when in the minimum extended position. This matching focuses the light pattern reflected through the lens arrangement into a target that requires spot lighting. When the second lens is retracted into the maximum extended position, the cooperating surfaces of the lenses form a diffused light pattern for providing ambient artificial light. Because the lens arrangement is constructed as explained above, the adjustment mechanism may be adapted to inside a frame such that the outer dimensions of the frame remain unchanged regardless of the position of the second lens. This is very advantageous for producing indoor lighting in places of commerce. Indeed, the second lens may be moved between the minimum and maximum extended position with a simple rotation adjustment means which may be provided to the frame at the end farthest away from the artificial light source. This has the benefit of being able to flush install the illuminator. Furthermore, as the adjustment mechanism can be arranged to the end farthest away from the artificial light source, remote controlled manipulation means, such as a step motor, may be provided to the illuminator for adjusting the light pattern from a distance.

While it is appreciated that it is advantageous for an illuminator, which is intended to be used as fixed source of light, to produce a variety of different light patterns, the present construction is also beneficial in other applications. For example, the present construction is applicable for providing a flashlight, vehicular lighting or as a bicycle lamp, where in all applications it is advantageous to be able to adjust the light pattern without changing the outer dimensions of the illuminator.

Further advantages gained with aid of the invention are discussed thoroughly in connection with the description of corresponding exemplary embodiments.

### BRIEF DESCRIPTION OF DRAWINGS

In the following, exemplary embodiments of the invention are described in greater detail with reference to the accompanying drawings in which:

FIG. 1 presents a lens arrangement according to one embodiment in a minimum extended position and a diagram depicting the resulting distribution of light intensity,

FIG. 2a presents a detailed view of the first lens of FIG. 1,

FIG. 2b presents a detailed view of the second lens of FIG. 2,

FIG. 3 presents a detailed view of the path along which light refracts in a lens arrangement of FIG. 1,

FIG. 4 presents the lens arrangement of FIG. 1 in a intermediate position and a corresponding diagram depicting the resulting distribution of light intensity, and

FIG. 5 presents the lens arrangement of FIG. 1 in a maximum extended position and a corresponding diagram depicting the resulting distribution of light intensity.

### DETAILED DESCRIPTION OF EXEMPLARY EMBODIMENTS

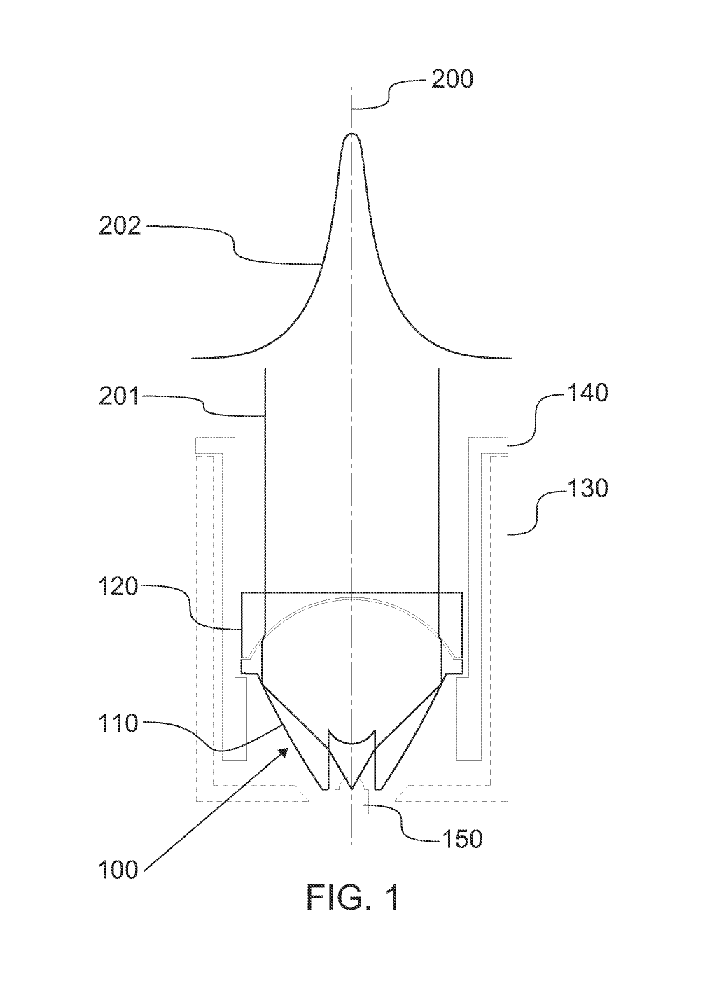

As can be seen from the embodiment of FIG. 1, a flush installed illuminator may be provided by arranging a novel lens arrangement 100 and a light source 150 into a frame 130 which is suitable for flush installation. The lens arrangement 100, which is shown in its minimum extended position in FIG. 1, includes a first lens 110, a second lens 120 and an adjustment mechanism 140 all arranged inside a frame 130. The combination of the frame 130, the lenses 110, 120 and the adjustment mechanism 140 form an illuminator housing which may be equipped with a light source 150. The frame 130 may be considered to include a first end, to which the light source 150 is fixed, and a second end opposing the first end for transmitting the light 201 of the light source 150 out of the illuminator housing. According to one embodiment, the light source 150 is an LED. The arrangement 100 has an optical axis 200 formed by the lenses 110, 120 to produce a light pattern 202. The formation of the optical axis 200 and the resulting light pattern 202 are discussed more thoroughly here after.

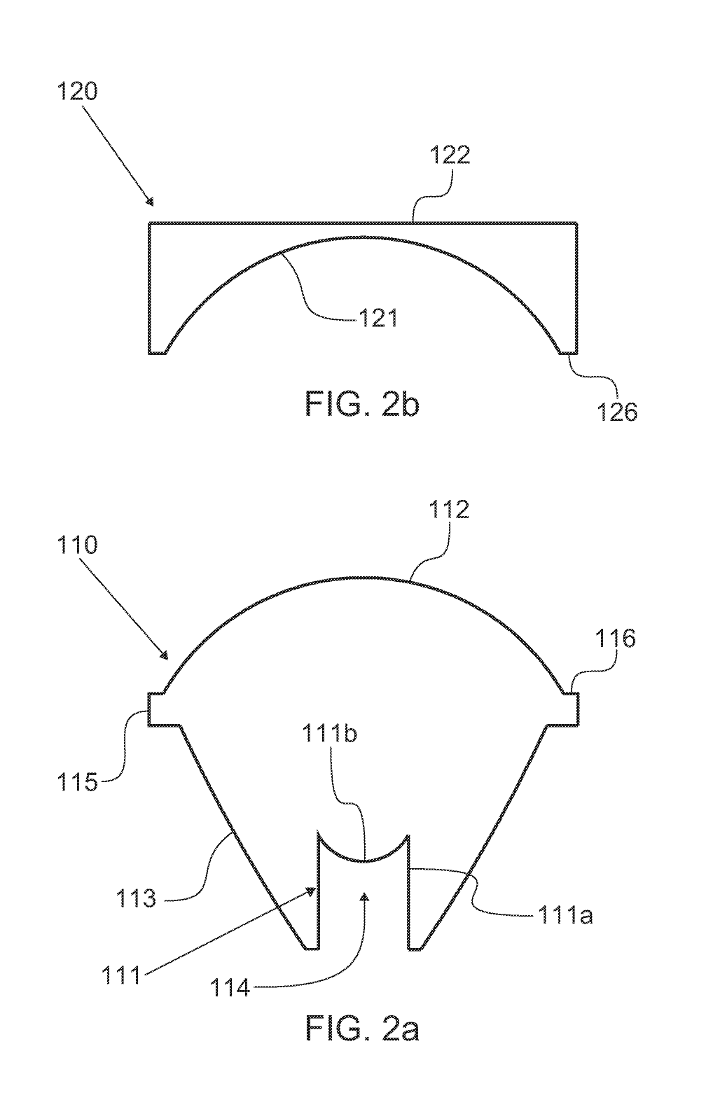

Turning now to the lens arrangement embodiment shown in FIG. 1, from which it is apparent that the lenses 110, 120 have three major surfaces. FIG. 2a shows in detail the shape of the first lens 110. The first lens 110 has an entry surface 111 which is shaped to receive a light source 150, such as an LED, in an embedded manner. The first lens 110 is therefore configured to be fixed to a light source 150. The entry surface 111 is considered to be the surface of the first lens 110 which is configured to receive light from the artificial light source 150 into the lens 110 as opposed to receiving any random light. For receiving a light source 150, the entry surface 111 of the first lens 110 includes a light source recession 114 which is configured to receive a light source 150 in an embedded manner. By embedding the light source 150 at least partially into the lens 110, the lens 110 is configured to collect a majority of radiation energy transmitted by the light source 150. According to one embodiment, the first lens 110 is configured to collect at least 90 percent of radiation energy transmitted by the light source 150. Accordingly, the first lens 110 is configured to transmit about 90 to 92% of the radiation energy transmitted by the light source 150.

The light source recession 114 is formed by two opposing side portions 111a and top portion 111b. The substantially flat side portions 111a are spaced apart and substantially parallel to the optical axis 200. The side portions 111a are connected by the top portion 111b over the optical axis 200. The top portion 111b is nonparallel to the optical axis 200 and is convex. In this context the shape of the lenses or portions thereof are examined in the direction of the artificial light travelling from the light source 150 through the lenses 110, 120. Therefore a convex top portion 111b is convex when examined from the light source, i.e. upwards from the bottom of FIG. 1.

The light source recession 114 may be modified or originally configured to receive a particular type of an LED. In the example illustrated in the Figures, the light source recession 114 is configured to receive a 1 to 10 W type commercial LED bulb, such as Cree XM-L, Cree MT-G, Luxeon S or similar.

Referring still to the embodiment of FIG. 2a which shows a conical flank surface of the first lens 110. In the illustrated embodiment, the conical flank surface is a so called ‘TIR surface’ 113 which stands for total internal reflection. The TIR surface 113 connects the entry surface 111 of the first lens 110 to the exit surface 112 thereof in the spatial extent defined by the optical axis 200 and in an outwardly flaring manner. The idea behind the TIR surface 113 is that the artificial light beam emanating from the light source 150 and reflecting through the entry surface 111 is reflected efficiently by the TIR surface 113 for minimizing radiation energy losses. It is therefore advantageous to use a TIR surface on the flank of the lens. According to one embodiment the TIR surface 113 is parabolic.

The first lens 110 also features a flange portion 115 for positioning the lens 110 to the illuminator, particularly to the frame 130 of an illuminator housing. The flange portion 115 is a radially extending part of the lens 115 which does not participate in shaping the light pattern but instead provides a mating surface for cooperating with the second lens 120. More specifically, the annular mating surface of the flange portion 115 of the first lens 110 is formed by the outer peripheral portion 116 of exit surface 112. The outer peripheral portion 116 may therefore be considered as a non-refractive part of the exit surface 112 or flange portion 115. As shown by FIG. 2b, the second lens 120 also has an outer peripheral portion 126 located at the entry side of the lens. More specifically, the outer peripheral portion 126 of the entry surface 121 forms a non-refractive and annular mating surface for alignment with the cooperating outer peripheral portion 116 of the first lens 110.

FIG. 2a also shows that in addition to an entry surface 111 and a TIR surface 113, the first lens 110 also includes an aspherical convex exit surface 112 for transmitting light 201 on the optical axis 200. More specifically, the exit surface 112 is convex when examined from the light source 150. Even more specifically, the exit surface 112 transmits light 201 received from the light source 150 via the entry surface 111 and TIR surface 113. Also, the entry and exit surfaces of the lens refer to surfaces nearer and farther from the light source 150, respectively, i.e. the surfaces through which the artificial light of the light source enters and exits the lens. The first lens 100 has a focal point (not shown) on the optical axis 200 opposite to the light source 150. The location of the focal point is the result of the shape of the exit surface 112 which, according to one embodiment, is hyperbolic. According to a specific embodiment, the exit surface 112 has one opening angle, wherein the exit surface 112 is free of annular bulges, but instead the exit surface profile features a continuous arc.

Referring now to the embodiments of FIGS. 1 and 2b which show the shape of the second lens 120. The second lens 120 is arranged to said optical axis 200 and superposed on top of the first lens 110. The second lens 120 includes an aspherical concave entry surface 121 which is configured to receive light 201 transmitted by the first lens 110, more specifically by the exit surface 112 of the first lens 110. The second lens 120 also has an exit surface 122 for transmitting light 201 from the arrangement 100. Again, the entry and exit surfaces of the lens refer to surfaces nearer and farther from the light source 150, respectively, i.e. the surfaces through which the artificial light of the light source enters and exits the lens. The concave entry surface 121 has substantially the same shape as that of the exit convex surface 112 of the first lens 110. In other words, the curvature of the entry surface 121 of the second lens is essentially the same as the curvature of the exit surface 112 of the first lens 110. Naturally, the essentially same curvature may depart from the exact curvature within reasonable tolerances yielding from conventional manufacturing tolerances. In other words, the curvature of the surfaces 112, 121 may deviate at least within tolerance defined by DIN ISO 2768-1 up to 30 mm class, whereas otherwise class M. Larger deviations may be allowed for lenses which are optimized for a particular light source type. According to one embodiment, the entry surface 121 of the second lens 120 is hyperbolic. According to a specific embodiment, the surface 121 has one opening angle, wherein the surface 121 is free of annular bulges, but instead the exit surface profile features a continuous arc.

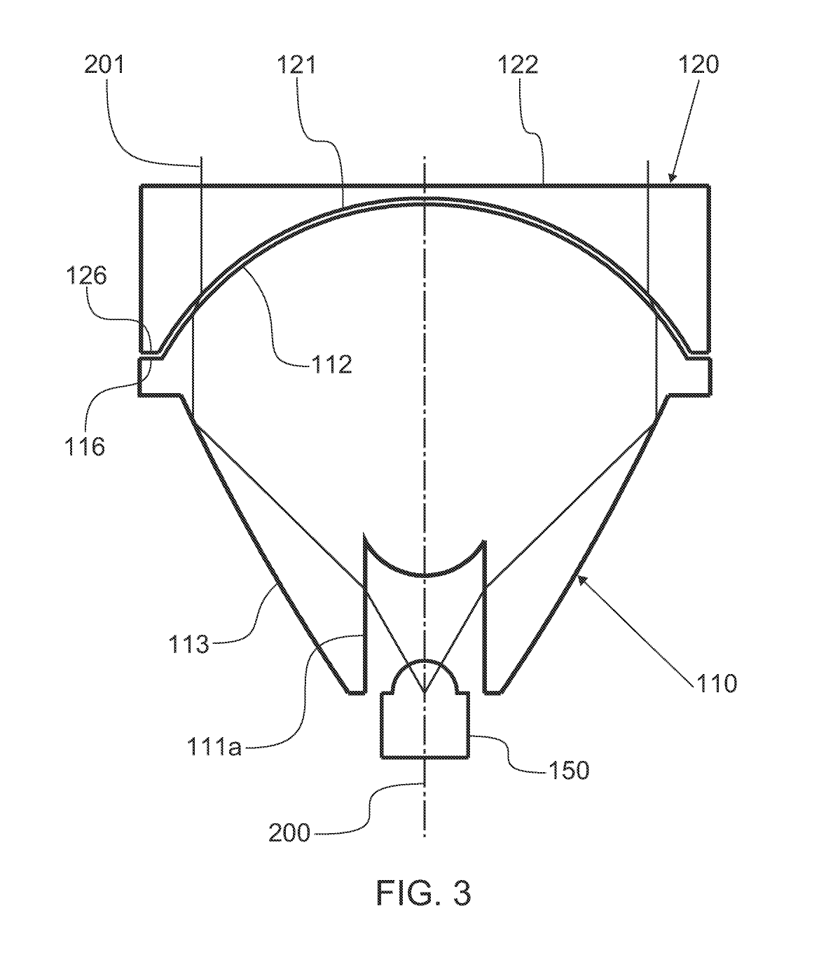

FIG. 3 shows the path of the light beam 201 more clearly. The light beam 201, transmitted originally by the artificial light source 150, experiences many subsequent deviations in angle before reaching the exit surface of the arrangement, i.e. the exit surface 122 of the second lens 120. First, the light penetrates the arrangement 100 by passing through the entry surface 111 of the first lens 110, namely through the side and top portions 111a, 111b. In FIG. 3, only two beams 201 travelling through the side portions 111a are shown. From FIG. 3 it is also apparent that the beam 201 is slightly refracted due to the difference between refractive indexes of the materials of the first lens 110 and the ambient medium, such as air. Next, the refracted beam 201 is reflected by the TIR surface 113 turning the beam 201 towards the second lens 120.

As can be seen from the embodiment of FIG. 3, there is a small continuous and even gap between the exit surface 112 of the first lens and the entry surface 121 of the second lens 120. Despite the minor gap, the first and second lens 110, 120 are considered to match such that the exit surface 112 is nested into the matching entry surface 121. Contact between said surfaces 112, 121 is therefore not necessary. In fact, according to one embodiment, only the corresponding outer peripheral portions 116, 126 of the lenses 110, 120, respectively, act as mating surfaces and make contact, whereby they are dimensioned such that the exit surface 112 and the entry surface 121 are free from contact for protecting the sensitive optical surfaces 112, 121. The mating peripheral portions 116, 126 of the lenses 110, 120 are the outer portions of the surfaces of the cooperating lenses which do not participate in refracting the light beam 201 (cf. also FIGS. 2a and 2b).

Referring still to the embodiment of FIG. 3 which shows that the beam 201—traveling through the exit surface 112 of the first lens 110, the entry surface 121 of the second lens 120 and the small gap there between—experiences two consecutive refractions. The refractions are caused by differences between refractive indexes of the materials of the lenses 110, 120 and the ambient medium, such as air. As a result of said refractions the beam 201 is eventually pointed substantially parallel to the optical axis 200. In the illustrated example, the exit surface 122 of the second lens 120 is essentially planar, whereby the beam 201 is refracted minimally or none at all when exiting the second lens 120 and entering the ambient medium. The exit surface 122 may however have small or deliberate geographical deviations for fine adjustment of the light pattern according to known methods.

Referring now to the embodiment of FIGS. 1, 4 and 5 which show the lens arrangement 100 in three different positions producing three different light patterns. FIG. 1 illustrates the first and second lens 110, 120 in a minimum extended position, wherein the convex exit surface 112 of the first lens 110 is nested into the matching concave entry surface 121 of the second lens 120. The light beam 201 travels from the light source 150 through lenses 110, 120 and exits the arrangement 100 as discussed above with reference to FIG. 3. The light pattern produced with the illustrated minimum extended position is a spot-like lighting pattern for bringing out a particular item in a place of commerce, for example. The corresponding distribution of light intensity of such a spot-like pattern is plotted out in the diagram 202 which is presented in FIG. 1. The diagram 202 shows that indeed the light intensity peaks at the optical axis 200. The diagram 202 is plotted such to define an angle according to the so called FWHM (full width, half maximum) principle, wherein the spread angle of the optics is the horizontal value, in which the diagram intercepts 50 percent of the maximum.

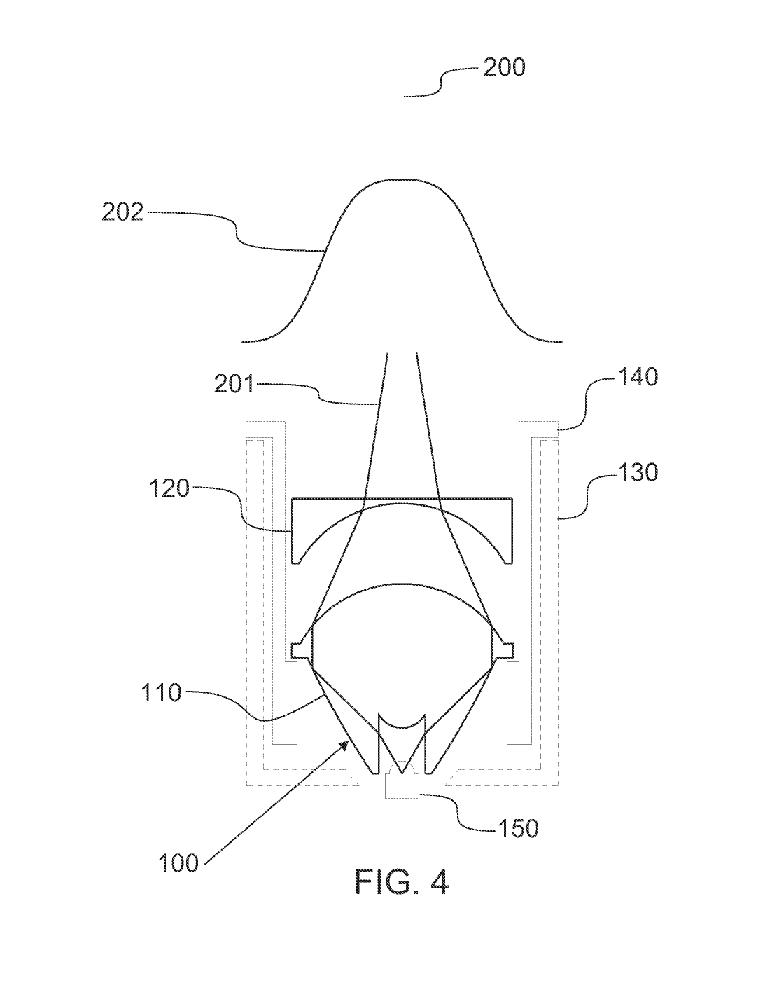

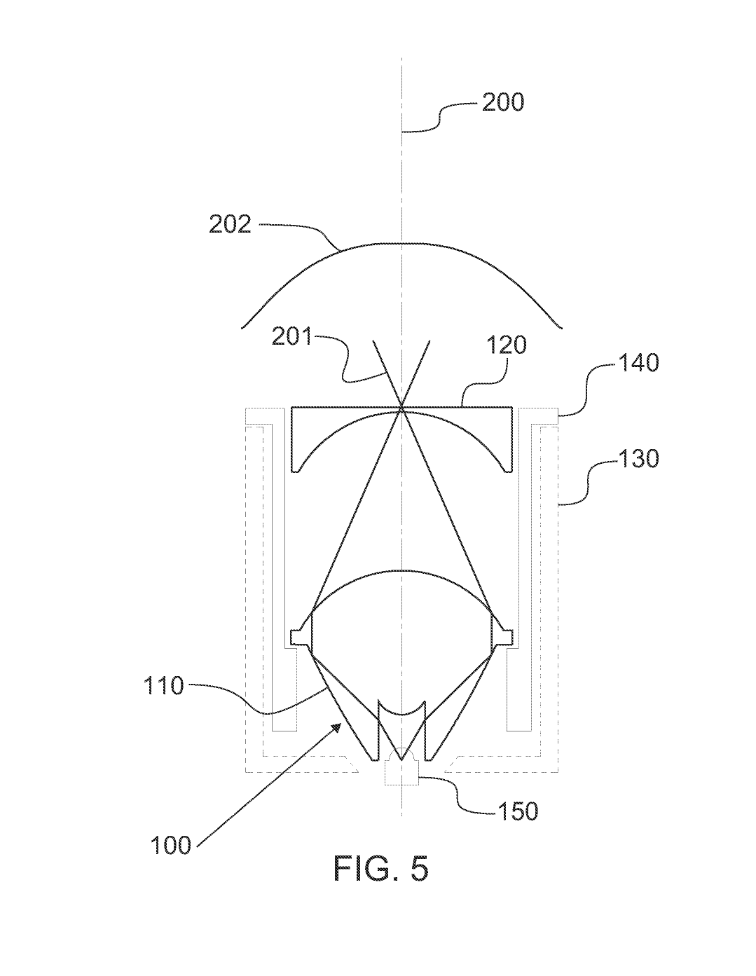

FIG. 4 shows the arrangement 100 in an intermediate position between the minimum extended position (FIG. 1) and maximum extended position (FIG. 5). In the intermediate position, the second lens 120 is retracted from the first lens 110 by means of the adjustment mechanism 140. The adjustment mechanism 140 is being configured to move the second lens 120 continuously along the optical axis 200 in respect to the first lens 110 between minimum and maximum extended positions. The movement of the second lens 120 is continuous in the sense that, in addition to the extreme positions, the second lens 120 is free to travel there between in a stepless fashion for providing a smooth transition between a spot-like and diffused light output.

According to one embodiment, the adjustment mechanism 140 includes converting means which is configured to convert rotational movement of the adjustment mechanism 140 in respect to the first lens 110 into axial movement of the second lens 120 in respect to the first lens 110 along the optical axis 200. Such converting means may be provided by fixing the second lens 120 within the surrounding profile of the adjustment means 140 and arranging a threaded connection between said profile and the second lens 120 and providing a bearing (not shown) between the profile of the adjustment means 140 and surrounding frame 130. Thus, the surrounding frame 130 is stationary while the profile of the adjustment means 140 is free to rotate within the stationary frame 130 without axial deviation. As the second lens 120 is attached to the profile of the adjustment means 140 through threaded connection, the rotation between the profile and the second lens 120 causes the lens 120 to travel axially and therefore in respect to the first lens 110. The converting means may therefore be manipulated by turning the profile from the outer flange portion extending radially from the profile at the second end of the frame 130. According to a further embodiment (not shown), remote controlled manipulation means, such as a step motor, may be configured to rotate said outer flange portion extending radially from the profile for adjusting the light pattern of the illuminator from a distance.

In the intermediate position illustrated by FIG. 4, the exit surface 112 of the first lens 110 and the entry surface 121 of the second lens 120 are not considered to be nesting but clearly spaced apart so that the medium between the lenses 110, 120 has a refracting effect on the light beam 201. By retracting the surfaces 122, 121, the resulting light pattern is widened from the spot-like light pattern of FIG. 1. This effect can be seen from the diagram 202 showing that there is less of a peak in light intensity at the optical axis 200. Instead, the light intensity is spread more evenly about the optical axis 200 resulting in a wider beam of light for providing more diffused light.

In the maximum extended position illustrated by FIG. 5, the first and second lens 110, 120 are in their most retracted position, wherein the second lens 120 lies at the focal point of the first lens 110. As seen from FIG. 5, the light beams 201 refracted by the first lens 100 are focused to the center portion of the second lens 120. As the center portion of the second lens 120 is the thinnest portion, light beams 201 are refracted minimally or—in an optimal scenario—none at all. This results in a very wide beam of light which is illustrated by the diagram 202 showing that the intensity of light is spread evenly about the optical axis 200 exhibiting barely any peak about said axis. Accordingly, the first and second lens 110, 120 are designed to cooperate such that the light patter transmitted from the lens arrangement 100 is wider in the maximum extended position than in the minimum extended position of the lenses 110, 120. Also as shown by FIG. 5, even at its most extended position, the arrangement does not cause the length of the device to increase, but the exit surface 122 of the second lens 120 is aligned with the terminal end of the adjustment mechanism 140.

As mentioned briefly, the lens arrangement 100 may be used in connection with an illuminator housing to create an illuminator which may be flush installed into a receiving structure, such as commercial furniture. Such an illuminator housing therefore includes a frame 130 and a lens arrangement 100, the first lens 110 of which is fixed to the frame. According to one embodiment, the illuminator housing also includes an artificial light source 150, such as an LED, which is also fixed to the frame 130. The adjustment mechanism 140 of the lens arrangement 100 is adapted to the frame 130 in a movable manner. More specifically, the adjustment mechanism 140 is arranged to at least partially within the frame 130 and configured to move the second lens 120 along the optical axis 200 in respect to the frame 130 between a minimum and maximum extended position. According to another embodiment, the adjustment mechanism 140 is arranged wholly within the frame 130. In the minimum extended position (FIG. 1), the lenses 110, 120 are stacked at the first end of the frame 130. In the maximum extended position (FIG. 5), the second lens 120 lies at the second end of the frame 130. The adjustment mechanism 140 therefore converting means which is configured to convert rotational movement of the adjustment mechanism 140 in respect to the frame 130 into axial movement of the second lens 120 in respect to the frame 130 along the optical axis 200.

According to one embodiment, the illuminator housing is configured for flush installation. Flush installation is enabled by constructing the frame 130, which encloses the lens arrangement 100, as an outer envelope with minimal amount of or no protrusions. Furthermore, flush installation may be facilitated by constructing the adjustment means 140 as shown in the Figs., wherein the lenses are manipulated by turning the profile of the means 140 from the outer flange portion extending radially from the profile at the second end of the frame 130.

Furthermore, the above description is only to exemplify the invention and is not intended to limit the scope of protection defined by the appended claims. Indeed, it will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

TABLE 1
LIST OF REFERENCE NUMBERS.

| Number | Part |
|---|---|
| 100 | lens arrangement |
| 110 | first lens |
| 111 | entry surface |
| 112 | exit surface |
| 113 | TIR surface |
| 114 | light source recession |
| 115 | flange portion |
| 116 | peripheral surface portion |
| 120 | second lens |
| 121 | entry surface |
| 122 | exit surface |
| 126 | peripheral surface portion |
| 130 | frame |
| 140 | adjustment mechanism |
| 150 | light source |
| 200 | optical axis |
| 201 | light beam |
| 202 | diagram illustrating distribution of light intensity |

1. A lens arrangement for an illuminator, the arrangement comprising:
a first lens configured to be fixed to an artificial light source and comprising an aspherical convex exit surface for transmitting light received from the light source on an optical axis, the first lens having a focal point on the optical axis,
a second lens arranged to said optical axis and comprising an aspherical concave entry surface being configured to receive light transmitted by the first lens and an exit surface for transmitting light from the arrangement, the concave entry surface having substantially the same shape as that of the exit convex surface of the first lens,
an adjustment mechanism connected to the second lens and being configured to move the second lens along the optical axis in respect to the first lens between:
i. a minimum extended position, wherein the convex exit surface of the first lens is nested into the matching concave entry surface of the second lens, and
ii. a maximum extended position, wherein the second lens lies at the focal point of the first lens.

2. The lens arrangement according to claim 1, wherein the light source is an LED.

3. The lens arrangement according to claim 1, wherein the first lens comprises an entry surface which is configured to receive light from the light source into the lens.

4. The lens arrangement according to claim 3, wherein the entry surface of the first lens is configured to collect at least 90 percent of radiation energy transmitted by the light source.

5. The lens arrangement according to claim 3, wherein the entry surface comprises at least one side portion which is substantially parallel to the optical axis and a top portion which is nonparallel to the optical axis.

6. The lens arrangement according to claim 5, wherein the top portion of the entry surface of the first lens is convex.

7. The lens arrangement according to claim 3, wherein the entry surface comprises two opposing side portion which are spaced apart and both substantially parallel to the optical axis, wherein the convex top portion connects the side portions over the optical axis.

8. The lens arrangement according to claim 7, wherein the entry surface comprises a light source recession which is configured to receive a light source in an embedded manner, the light source recession being formed by said two opposing side portions and top portion.

9. The lens arrangement according to claim 3, wherein the entry surface is shaped to receive a light source in an embedded manner.

10. The lens arrangement according to claim 1, wherein the first lens comprises a lateral TIR surface connecting the entry surface to the exit surface in the spatial extent defined by the optical axis in an outwardly flaring manner.

11. The lens arrangement according to claim 10, wherein the TIR surface is parabolic.

12. The lens arrangement according to claim 1, wherein the first lens comprises a radially extending part for providing a mating surface for cooperating with the second lens.

13. The lens arrangement according to claim 12, wherein the outer peripheral portion of exit surface of the first lens forms the annular mating surface of the flange portion of the first lens, wherein the second lens comprises a corresponding outer peripheral portion, which is located at the entry surface of the second lens thus forming a non-refractive and annular mating surface for alignment with the cooperating outer peripheral portion of the first lens.

14. The lens arrangement according to claim 1, wherein the focal point of the first lens lies on the optical axis opposite to the light source.

15. The lens arrangement according to claim 1, wherein the exit surface of the second lens is essentially flat.

16. The lens arrangement according to claim 15, wherein the exit surface of the first lens is hyperbolic.

17. The lens arrangement according to claim 1, wherein the first and second lens are designed to cooperate such that the light patter transmitted from the lens arrangement is wider in the maximum extended position than in the minimum extended position of the lenses.

18. The lens arrangement according to claim 1, wherein the adjustment mechanism comprises converting means configured to convert rotational movement of the adjustment mechanism in respect to the first lens into axial movement of the second lens in respect to the first lens along the optical axis.

19. An illuminator housing comprising:
a frame,
a first lens fixed to the frame and configured to be fixed to a light source and comprising an aspherical convex exit surface for transmitting light received from the light source on an optical axis, the first lens having a focal point on the optical axis,
a second lens arranged to said optical axis and comprising an aspherical concave entry surface being configured to receive light transmitted by the first lens and an exit surface for transmitting light from the arrangement, the concave entry surface having substantially the same shape as that of the exit convex surface of the first lens, and
an adjustment mechanism connected to the frame and to the second lens, the mechanism being configured to move the second lens along the optical axis in respect to the first lens between:
i. a minimum extended position, wherein the convex exit surface of the first lens is nested into the matching concave entry surface of the second lens, and
ii. a maximum extended position, wherein the second lens lies at the focal point of the first lens.

20. The illuminator housing according to claim 19, wherein the illuminator housing comprises an artificial light source which is fixed to the frame adjacent to the first lens opposite to the second lens.

21. The illuminator housing according to claim 20, wherein the frame comprises a first end, to which the light source is fixed, and a second end opposing the first end for transmitting the light of the light source out of the illuminator housing.

22. The illuminator housing according to claim 20, wherein the adjustment mechanism is configured to move the second lens along the optical axis in respect to the first lens between:
a minimum extended position, wherein the lenses are stacked at the first end of the frame, and
a maximum extended position, wherein the second lens lies is at the second end of the frame.

23. The illuminator housing according to claim 19, wherein the adjustment mechanism is arranged to at least partially within the frame.

24. The illuminator housing according to claim 19, wherein the adjustment mechanism comprises converting means configured to convert rotational movement of the adjustment mechanism in respect to the frame into axial movement of the second lens in respect to the frame along the optical axis.

25. The illuminator housing according to claim 19, wherein the housing is configured for flush installation.
